(19) United States
(12) Patent Application Publication
(10) Pub. No.: US 2024/0313516 A1
(43) Pub. Date: Sep. 19, 2024

(54) ELECTRIC VEHICLE CHARGING ARRANGEMENT

(71) Applicant: ELECTRICA LIVE (UK) LIMITED, London (GB)

(72) Inventors: Christopher BIBB, Shrewsbury (GB); John PATERSON, Cambridgeshire (GB)

(21) Appl. No.: 18/573,769

(22) PCT Filed: Jun. 22, 2022
(86) PCT No.: PCT/GB2022/051593

§ 371 Date: Dec. 22, 2023

(30) Foreign Application Priority Data
Jun. 22, 2021 (GB) 2108957.8

(51) Int. Cl. H02G 9/06; B60L 53/14; H02J 7/00

(52) U.S. Cl. CPC H02G 9/065; B60L 53/14; H02J 7/0042

(57) ABSTRACT

An arrangement for providing a charging connection for an electric vehicle, the arrangement comprising: an elongate groove formed in a surface of a pavement or sidewalk; and a conduit received within the elongate groove, the conduit having an open state and a closed state, wherein in the open state the conduit defines an opening at the surface of the pavement or sidewalk, through which at least a portion of a vehicle charging cable may be inserted into the conduit, and in the closed state an exposed surface of the conduit at the surface of the pavement or sidewalk covers the vehicle charging cable.

### FIELD OF THE INVENTION

The invention relates generally to the field of electric vehicles, and more specifically to an arrangement for charging electric vehicles.

### BACKGROUND

Providing access to on-street charging is a significant barrier to the wide-scale adoption of electric vehicles and has been described as the major issue slowing the transition from vehicles powered by internal combustion engines. Electric vehicle owners with homes that do not have driveways or garages, must charge their vehicle while parked on the street. The presence of the charging cable across the pavement or sidewalk creates a trip hazard for pedestrians and other pavement users.

Attempts have been made to provide roadside charging units that alleviates this issue. However, the building work to install these charging units and connect them to the grid requires approval from local authorities, creating significant delays. In addition, these solutions often require a minimum number of units per street to be financially viable, with parking space denied to residents who do not yet have an electric vehicle. This leads to objections from residents and increased difficulty in obtaining approval from local authorities.

It is against this background that this invention has been devised.

### SUMMARY OF THE INVENTION

According to a first aspect of the invention, there is provided an arrangement for providing a charging connection for an electric vehicle. The arrangement comprises an elongate groove formed in a surface of a pavement or sidewalk and a conduit received within the elongate groove, the conduit comprising: an outer sleeve comprising a first open channel; and an inner sleeve arranged within the first open channel, the inner sleeve comprising a second open channel for receiving a vehicle charging cable, the conduit having an open state and a closed state. In the open state, the conduit defines an opening at the surface of the pavement or sidewalk, through which at least a portion of the vehicle charging cable may be inserted into the second open channel of the conduit. In the closed state, an exposed surface of the conduit at the surface of the pavement or sidewalk covers the vehicle charging cable. The inner sleeve of the conduit is rotatable within the outer sleeve to move the conduit between the open and closed states.

Moving the conduit from the closed state to the open state may reveal the opening at the surface of the pavement or sidewalk.

The first open channel may define a first longitudinal aperture and the second open channel may define a second longitudinal aperture. The first and second longitudinal apertures may be mutually aligned when the conduit is in the open state. The mutually aligned apertures may reveal the opening at the surface of the pavement or sidewalk.

The exposed surface of the conduit may be a surface of the inner sleeve and may be a surface of the inner sleeve that is diametrically opposed to the second slot. The exposed surface of the conduit may be substantially flush with the surface of the pavement or sidewalk when the conduit is in the closed state.

The inner sleeve may rest against a bearing arrangement in the outer sleeve. The bearing arrangement may comprise roller bearings against which the inner sleeve rotates to move the conduit between the open and closed states.

The inner sleeve may be supported by an elastically resilient member. The elastically resilient member may comprise a spring. The elastically resilient member may alternatively comprise an elastomeric material.

The conduit may comprise a base structure received within the groove. The outer sleeve may be integral with the base structure, for example being formed integrally with the base structure. The base structure may be formed from rubber or another resiliently deformable material. The base structure may comprise an outwardly-extending skirt. The skirt may be covered by an infill.

The groove and the conduit may extend transversely across the width of the pavement or sidewalk. The groove and the conduit may extend between a domestic residence on one side of the pavement or sidewalk and a road providing on-street parking on the other side of the pavement or sidewalk. The groove in the pavement or sidewalk may be a shallow groove and may have a depth of approximately 80 mm or less, preferably 70 mm or less.

The outer and/or the inner sleeve may be extruded parts and may be made of plastic, metal, or a composite material such as fibre-reinforced polymer. The outer and/or the inner sleeve may be plastic extrusions or aluminium extrusions. The outer and/or inner sleeve may alternatively be formed by casting.

According to a third aspect of the invention, there is provided a method of installing an arrangement for providing a charging connection to an electric vehicle. The method comprises forming an elongate groove within a pavement or sidewalk and providing a conduit in said groove. The conduit comprises: an outer sleeve comprising a first open channel; and an inner sleeve arranged within the first open channel, the inner sleeve comprising a second open channel for receiving a vehicle charging cable, wherein the inner sleeve is rotatable within the outer sleeve to move the conduit between open and closed states. The method may comprise forming the groove to a depth of 80 mm or less.

The conduit may comprise a base structure and the method may further comprise installing the base structure within the groove and subsequently installing the inner sleeve within the base structure.

According to a fourth aspect of the invention, there is provided a method for charging an electric vehicle using the arrangement discussed above. The method comprises: providing a charging cable; inserting a portion of the charging cable into a conduit through an opening defined at the surface of a pavement or sidewalk when the conduit is in an open state; closing the conduit such that an exposed surface of the conduit at a surface of a pavement or sidewalk covers said portion of the vehicle charging cable; connecting a first end of the charging cable to a power supply; and connecting a second end of the charging cable to the electric vehicle.

The method may further comprise rotating the inner sleeve within the outer sleeve to reveal the opening in the pavement or sidewalk, inserting the vehicle charging cable into the second open channel, and rotating the inner sleeve within the outer sleeve to cover the vehicle charging cable at the surface of the pavement or sidewalk.

The power supply may be a domestic power supply. The electric vehicle may be parked on a road.

In other examples, the exposed surface of the conduit may be defined by a flap or panel. The flap or panel may cover the vehicle charging cable within the conduit. A flap or panel may be hinged along one edge, and may be pivoted about the hinge to move the conduit between open and closed states. Alternatively, a slidable panel may be used to transition the conduit between open and closed states.

In any of the above examples, the conduit may comprise a biasing mechanism, for example a spring, to bias the conduit into the closed state. The conduit may comprise means for automatically moving the conduit between the open and closed states. The means for automatically moving the conduit between the open and closed states may comprise a motor or other suitable drive means. The means for automatically moving the conduit between the open and closed states may be remotely operable.

Optional features described above in relation to any one aspect of the invention are equally applicable to the other aspects of the invention. Repetition of such features is avoided purely for reasons of conciseness.

### BRIEF DESCRIPTION OF THE DRAWINGS

So that it may be more readily understood, the invention will now be described with reference to the following drawings, in which:

FIG. 1 shows an arrangement for charging an electric vehicle comprising a cross-pavement conduit for accommodating a charging cable;

FIG. 2 is a cross-sectional view of an outer sleeve of the conduit used in the arrangement of FIG. 1;

FIG. 3 is a cross-sectional view of an inner sleeve of a conduit used in the arrangement of FIG. 1;

FIG. 4 is a cross-sectional view of the conduit embedded in the pavement, wherein the conduit is in an open state;

FIG. 5 is a cross-sectional view of the conduit embedded in the pavement, wherein the conduit is in a closed state;

FIG. 6 is a cross-sectional view of an alternative arrangement for charging an electric vehicle, in which the conduit comprises a base structure;

FIG. 7 shows a cross-sectional view of another alternative arrangement for charging an electric vehicle, in which the outer sleeve of the conduit is formed integrally with the base structure of the conduit;

FIG. 8 shows a cross-sectional view of a further alternative arrangement for charging an electric vehicle, in which the inner sleeve of the conduit rests against a bearing arrangement;

FIG. 9 shows a plan view of a base structure for the conduit of FIG. 7 or 8 comprising a series of skirt sections; and

FIGS. 10a and 10b show perspective and plan views respectively of a base structure for the conduit of FIG. 7 or 8 comprising a series of cavities.

### DETAILED DESCRIPTION

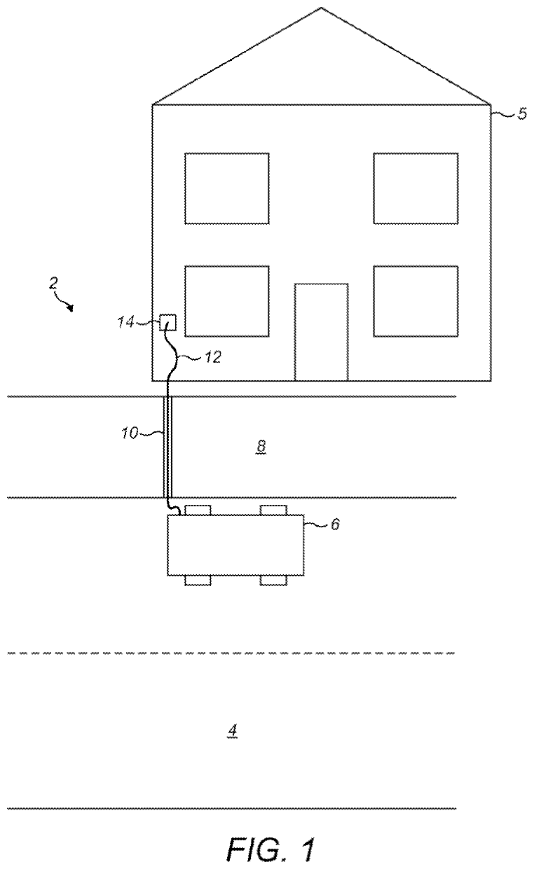

FIG. 1 schematically shows a section of a residential street 2 that includes a road 4, a domestic residence 5 and an electric vehicle 6. As can be seen in FIG. 1, the domestic residence 5 lacks off-street parking and so the electric vehicle 6 is seen parked on the road 4, in front of the domestic residence 5. Between the domestic residence 5 and the road 4 is a pavement (or sidewalk, or other pedestrian footway) region 8. An elongate conduit 10 is embedded within the pavement 8. The conduit 10 extends transversely across the width of the pavement 8. The conduit 10 receives a portion of a charging cable 12 that provides a charging connection to the electric vehicle from a power supply 14 associated with the domestic residence 5.

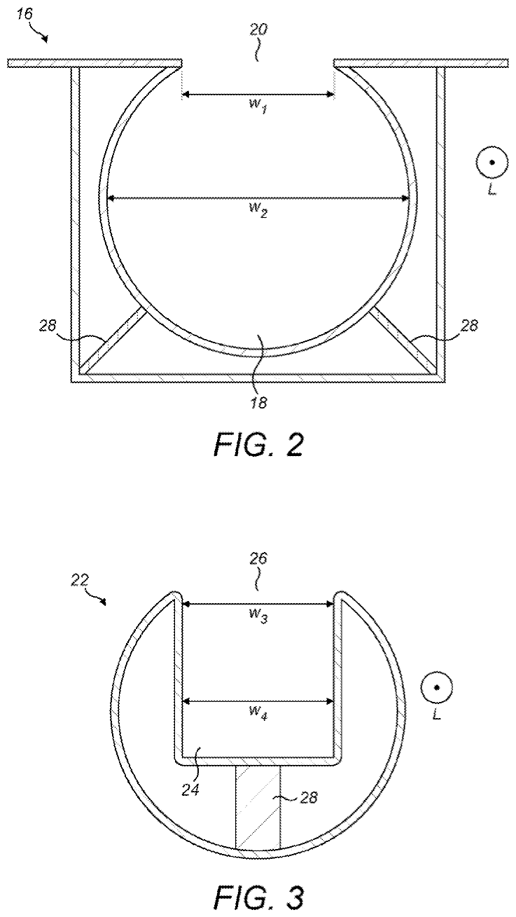

The conduit 10 will now be described in more detail with reference to FIGS. 2 and 3. The conduit comprises an outer sleeve 16 and an inner sleeve 22, shown in FIGS. 2 and 3, respectively.

The outer sleeve 16 is elongate and extends along a longitudinal axis L that is normal to the plane of the page in FIG. 2. As can be seen in FIG. 2, the outer sleeve 16 is generally rectangular in a transverse cross-section normal to the longitudinal axis L. The outer sleeve 16 comprises a first open channel 18, which extends longitudinally along the length of the outer sleeve 16. The first open channel 18 comprises a first longitudinally extending slot or aperture 20 that provides access to the first channel 18. The first channel 18 is substantially cylindrical in shape and is shown to have a substantially circular cross-section in FIG. 2. It will be appreciated that the substantially circular cross-section of the first channel 18 means that the first aperture 20 has a width w₁ that is narrower than a width w₂ of the first channel 18 at its widest point. The first aperture 20 extends over an angular range between approximately eleven o′clock and one o′clock in this example.

The inner sleeve 22 is, like the outer sleeve 16, elongate along a longitudinal axis L. The inner sleeve is substantially cylindrical in shape and is shown to have a substantially circular cross-section in FIG. 3. The inner sleeve 22 comprises a second open channel 24, which extends longitudinally along the length of the inner sleeve 22. The second channel 24 comprises a second longitudinally extending slot or aperture 26 that provides access to the second channel 24. In this example, the second channel 24 is substantially rectangular in cross-section, so that the width w₃ of the second aperture 26 is substantially equal to the width w₄ of the second channel 24. The second channel 24 may have other suitable shapes in other examples.

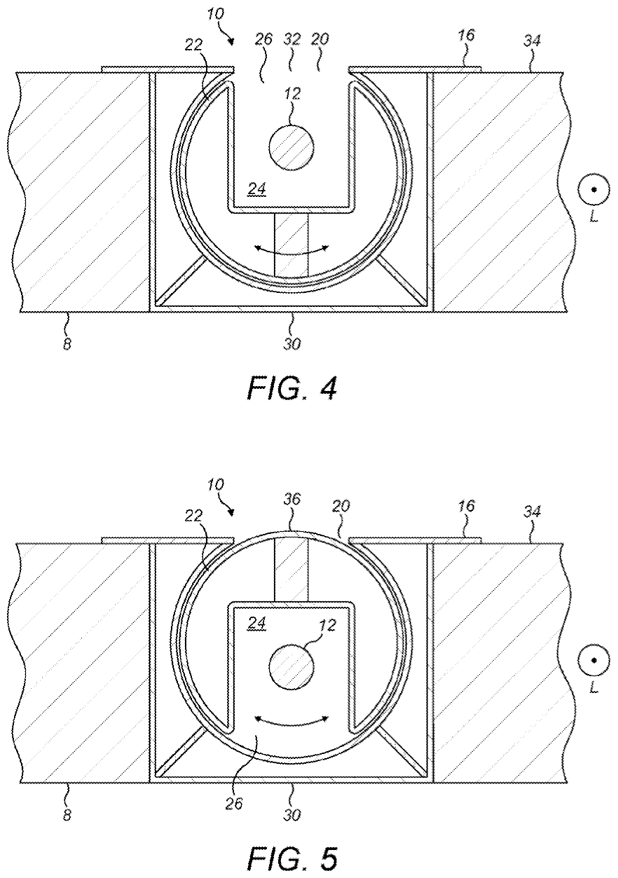

The inner sleeve 22 is configured to be received within the first channel 18 (as shown in FIGS. 4 and 5) such that the inner sleeve 22 is coaxial with the outer sleeve 16. When received within the first channel 18, the inner sleeve 22 is configured to be rotatable within the first channel 18 about the longitudinal axis L to vary the orientation of the second aperture 26 with respect to the first aperture 20. The inner sleeve 22 is retained within the first channel by the relative narrowness of the first aperture 20 when compared to the first channel 18 and inner sleeve 22 at their widest points.

The inner sleeve 22 is configured to receive a charging cable 12 within the second channel 24. The second channel 24 is deep enough and wide enough that standard cables for charging electric vehicles may be received therein completely, without the cable 26 protruding beyond the second aperture 26.

In preferred embodiments of the invention, the outer sleeve 16 and the inner sleeve 22 are plastic extrusions or aluminium extrusions. This enables the conduit 10 to be cost effective to manufacture yet durable in use. Alternatively, the outer sleeve 16 and inner sleeve 22 may be made from stainless steel or other suitably tough and durable material.

As can be seen in FIGS. 2 and 3, the outer sleeve 16 and the inner sleeve 22 may be substantially hollow extrusions that are supported by elongate ribs 28 that extend along the length of the outer sleeve 16 or inner sleeve 22, respectively. The ribs 28 enable the use of less material when forming the conduit 10, yet ensure that the outer sleeve 16 and inner sleeve 22 are strong enough to withstand long periods of use.

FIGS. 4 and 5 show cross-sections of the conduit 10 when embedded in the pavement 8. In both cases, the conduit 10 is embedded in a shallow, elongate groove 30 that is formed in the pavement 8. The outer sleeve 16 and the groove 30 in the pavement 8 are configured to be of a similar width and depth so that the conduit 10 fits snugly in the groove 30 when embedded therein. In other words, the external dimensions of the outer sleeve 16 are similar to the internal dimensions of the groove 30

In the arrangement shown in FIG. 4, the conduit 10 is arranged in an open state, wherein the second aperture 26 is aligned with the first aperture 20. When the conduit 10 is embedded in the groove 30 in the pavement 8 and is in the open state, the mutual alignment of the first and second apertures 20, 26 defines an opening 32 in the arrangement at a surface 34 of the pavement 8. The opening 32 therefore provides access to the second channel 24.

In contrast to the arrangement shown in FIG. 4, FIG. 5 shows the conduit 10 when arranged in a closed state. In the closed state, the inner sleeve 22 is positioned within the outer sleeve 16 such that the first and second apertures 20, 26 are diametrically opposed. When the conduit 10 is embedded in the groove 30 in the pavement 8 and is in the closed state, an exposed surface 36 of the inner sleeve 22 that is substantially diametrically opposed to the second aperture 26 is substantially flush with the surface 34 of the pavement 8. The exposed surface 36 therefore prevents access to the second channel 24.

The conduit 10 is movable between the open and closed states by rotation of the inner sleeve 22 within the outer sleeve 16. Rotation of the inner sleeve 22 brings the second aperture 26 into and out of mutual alignment with the first aperture 20, revealing and concealing the opening 32 when the conduit 10 is received within the groove 30 in the pavement 8. Moving the conduit 10 to the open state may be referred to as ‘opening’ the conduit 10, while moving the conduit 10 to the closed state may be referred to as ‘closing’ the conduit 10. Movement of the conduit 10 between the open and closed states may be actuated by knurled bezels (not shown) that are situated at one or both ends of the inner sleeve 22. Alternatively, movement of the conduit 10 between the open and closed states may be actuated by direct manipulation of the inner sleeve 22.

When the conduit 10 is in the open state, the second channel 24 can receive part of a charging cable 12 via insertion of the cable 12 through the opening 32. The conduit 10 can then be closed through rotation of the inner sleeve 22 within the outer sleeve 16 such that the exposed surface 36 of the inner sleeve 22 covers and conceals the charging cable 12. This prevents the cable 12 from presenting a trip hazard across the pavement 8. The fact that the exposed surface 36 is substantially flush with the surface 34 of the pavement 8 means that the conduit 10 itself does not present a trip hazard to pedestrians using the pavement 8.

In alternative embodiments of the invention, the conduit 10 may comprise a flap or panel to cover and conceal the charging cable 12. The conduit 10 may be transitioned between the open and closed states by sliding the flap or panel over the second channel 24. Alternatively, the conduit 10 may be transitioned between the open and closed states by the action of a hinge mechanism positioned along one side of the flap or panel. Regardless of the exact mechanism used to cover the charging cable 12, or to transition the conduit 10 between the open and closed states, the conduit 10 may also include a biasing mechanism, for example a spring, that biases the conduit 10 into the closed state. The conduit 10 may also include means for automatically transitioning the conduit 10 between the open and closed states, such as a motor. Such means may be operable remotely.

The invention also extends to a method for charging an electric vehicle using the apparatus described above. A charging cable 12 is provided and, with the conduit 10 in the open state, or opened by rotating the inner sleeve 22 within the outer sleeve 16 such that the opening 32 is revealed, the cable 12 is inserted into the second channel 24 of the conduit 10 through the opening 32. The conduit 10 is then closed by rotating the inner sleeve 22 within the outer sleeve 16 such that the exposed surface 36 of the conduit 10 is substantially flush with the surface 34 of the pavement 8. The exposed surface 36 covers and conceals the cable 12 within the second channel 24 such that it does not present a trip hazard to pedestrians on the pavement 8. The cable 12 is then connected to a power supply 14 at a first end and to the electric vehicle 6 at a second end, enabling a charging connection to be made between the power supply 14 and the electric vehicle 6.

The power supply 14 may be a domestic power supply and may conveniently include a socket located external to the domestic residence 5, as shown in FIG. 1. Alternatively, a socket may be located inside the domestic residence 5.

In certain embodiments of the invention, the conduit 10 may be provided as a modular unit. In such cases, the outer sleeve 16 and/or the inner sleeve 22 may be provided as multiple outer sleeve elements and/or inner sleeve elements. This enables the conduit 10 to be fitted to various different widths of pavement 8.

The apparatus and method described above enable a resident who does not have access to off-street parking (such as a garage or driveway) to charge an electric vehicle parked on the road adjacent to their house without the charging cable presenting a trip hazard to pedestrians who may be using the pavement. It is estimated that 43% of households in the UK do not currently have access to off-street parking. Furthermore, by enabling connection to the resident's domestic power supply, the cost of charging the electric vehicle is significantly reduced compared to third-party roadside charging, which may be up to six times more expensive. Reducing the running costs of an electric vehicle in this way helps mitigate one of the significant barriers to consideration of electric vehicles by consumers without access to off-street parking. By using a resident's domestic power supply, the apparatus can take advantage of the fact that the power supply is already individually monitored and billed, obviating the need for further administrative setup.

Receiving the charging cable within the conduit also helps protect the charging cable, both from the outside environment and from theft by pedestrians.

The apparatus, being relatively simple and discreet, presents an opportunity to expand the current provision of on-street vehicle charging whilst causing minimal disruption to the urban landscape and to road users while the apparatus is installed. The groove 30 in the pavement 8 may be formed to a depth of at most 80 mm, but is preferably formed to a depth of at most 70 mm, preferably between 50 and 60 mm, and more preferably to a depth of 55 mm. Ideally, the depth of the groove 30 is as shallow as possible. By forming the groove 30 at this depth, excavation of the groove 30 is quick and the apparatus is easy, cheap and quick to install. The limited depth of the groove 30 helps simplify the process of obtaining local approval since the groove will not interfere with existing subterranean pipes and cables, further expediting the installation process.

The fact that the apparatus is slim, simple, and relatively inexpensive allows for the possibility that it can be purchased by local authorities and subsequently installed where needed.

Without the need for a ‘minimum order’ for a street in order to qualify for installation of the apparatus, the provision of on-street vehicle charging can be individualised, further reducing the prospect of local objections from residents who do not yet own an electric vehicle.

The invention further extends to a method of installing the arrangement 10 described above. In a first step, a shallow, elongate groove 30 is formed within the pavement 8. The groove 30 may be formed by using a twin-bladed disc cutter to make parallel incisions a set distance apart to a maximum depth of 80 mm, preferably to a maximum depth of 70 mm. The area between the incisions is then excavated to a maximum depth of 80 mm, preferably to a maximum depth of 70 mm to provide a groove 30 that has a substantially constant depth of at most 80 mm, preferably 70 mm when measured from the surface 32 of the pavement 8. The conduit 10 is then received in the groove 30, where it is then ready to receive a charging cable 12 as described above.

The invention advantageously provides a permanent flush-fitting conduit affording safe passage of electric cables across a pavement or other pedestrian footway for the purpose of enabling on-street electric vehicle charging from an adjacent domestic electric vehicle charger and electricity supply.

The first channel 18 of the outer sleeve 16 may have a different shape to the circular cross-section exemplified above. For example, the first channel 18 may comprise a V-shaped cross-section in which the inner sleeve 22 is situated in order to reduce the number of points of contact between the inner sleeve 22 and the outer sleeve 16, and so reduce friction therebetween.

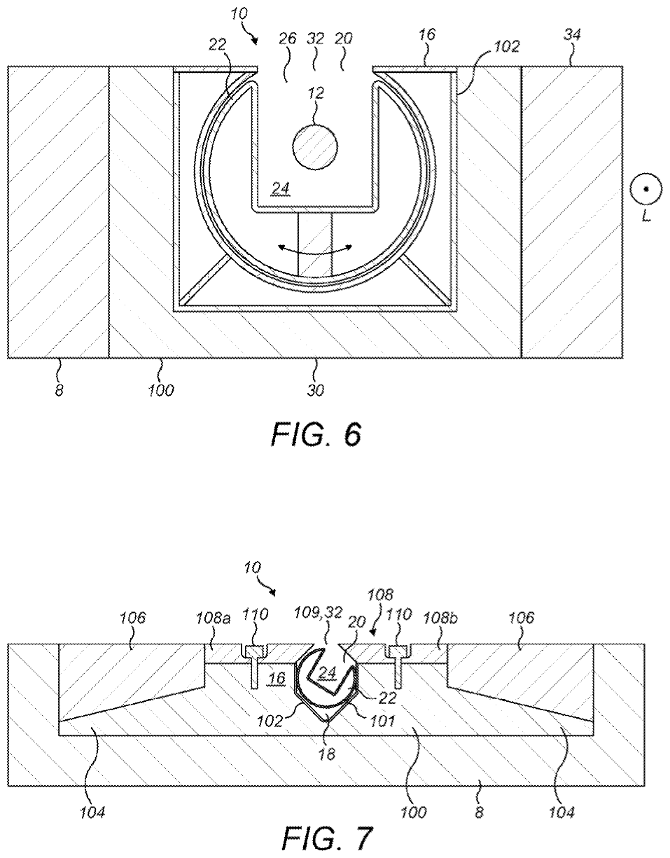

In addition, as shown in FIG. 6, the conduit 10 may comprise a base structure 100, which may be provided separately to the outer sleeve 16 and the inner sleeve 22. The base structure 100 is situated within the pavement 8 such that the base structure 100 is positioned in the groove 30, with the outer sleeve 16 then received in a groove or slot 102 within the base structure 100. The base structure may be made from a suitably durable and resiliently deformable material, such as rubber. The base structure 100 enables loads applied to the conduit 10, such as from a vehicle temporarily mounting the pavement 8, to be spread and absorbed, thus protecting the outer sleeve 16 and inner sleeve 22 from damage.

The presence of the base structure 100 is also advantageous from an implementation perspective. Local authorities typically must formally adopt devices set into the highway or pavement and so bear maintenance costs and control access to the device. In this case, the local authority responsible for the road into which the conduit 10 is to be set can adopt the base structure 100 and install it in the pavement 8. The remaining parts of the conduit 10 can then be purchased by a resident and installed in the base structure 100 upon payment of a license or rental fee to the local authority.

FIG. 7 shows an improved arrangement in which the outer sleeve 16 is integrally formed with the base structure 100. The slot 102 of the base structure 100 therefore defines the first open channel 18 and the first aperture 20 of the conduit 10, in the same way as described above. The first open channel 18, as discussed above, may comprise a V-shaped cross-section to reduce the number of points of contact between the first open channel 18 and the inner sleeve 22. In the case where the base structure 100 is made from a material with a relatively high co-efficient of friction, such as rubber, the slot 102 may be provided with a liner 101 to reduce friction between the inner sleeve 22 and the outer sleeve 16. Forming the outer sleeve 16 integrally with the base structure 100 reduces manufacturing cost and avoids the need to weld, or otherwise assemble the outer sleeve 16 from a number of different constituent parts.

The base structure 100 (and consequently the outer sleeve 16) of FIG. 7 is significantly wider than the outer sleeve 16 of previous embodiments. This is in part due to the presence of a skirt 104 that extends outwardly from a central portion 103 of the base structure 100.

The increased width of the base structure 100 increases the stability of the base structure 100, and thus the conduit 10, within the pavement 8. The skirt 104 is filled over with an infill 106, which can be asphalt or another suitable hard-wearing paving material. The infill 106 and the skirt 104 cooperate to hold the conduit 10 in place within the pavement 8. This helps to allay concerns of local authorities relating to future maintenance costs of the arrangement and improves the prospects for the arrangement to be considered for adoption by local authorities. The infill 106 can also be shaped, or haunched, in order to bridge the gap between the top of the conduit 10 and the pavement 8 in order to minimise any trip hazard if the surface of the pavement 8 is uneven.

The conduit further comprises a top cover 108, which can be secured in place using bolts 110, or another suitable fixture, such as a self-tapping screw. The top cover 108 may conveniently be split into two parts 108a, 108b, separated by a gap 109 to allow for insertion of a vehicle charging cable 12 into the conduit 10. In this way, the gap 109 functions in a similar way to the first aperture 20 described above in creating the opening 32 through which the vehicle charging cable 12 may access the second channel 24. The fact that the top cover 108 is removable means that when the inner sleeve 22 is not in place within the base structure 100, a blank cover that fully covers the slot 102 may instead be secured to the base structure 100 to protect the interior of the slot 102 (i.e., the first open channel 18) from damage.

FIG. 8 shows an alternative arrangement to that of FIG. 7, in which the outer sleeve 16 is again integral with the base structure 100. In the embodiment of FIG. 8, however, there is no liner 101 in place in the slot 102. In place of the liner 101, the inner sleeve 22 rests against, and is supported by, a bearing arrangement 110. A number of such bearing arrangements 110 may be present along the length of the arrangement in the longitudinal direction L. Each bearing arrangement comprises a pair of roller bearings 112. The inner sleeve 22 rests directly against the roller bearings 112 and is therefore rotatable between the open and closed states due to the rotating action of the roller bearings 112. The roller bearings further reduce the friction experienced in rotating the inner sleeve 22 between the open and closed states.

The bearing arrangement 110 or liner 101 of the conduit 10 may be supported by an elastically resilient member. The elastically resilient member enables downward movement of the inner sleeve 22 in response to bending loads applied to the conduit 10 from above, such as from errant vehicles accidentally driving over the pavement 8, thereby protecting the conduit 10.

In the embodiment shown in FIG. 8, the elastically resilient member takes the form of a cradle 114, on which the bearing arrangement 110 is mounted. The cradle incorporates springs 116 to provide the elastic resilience to the cradle 114. An advantage of providing the elastically resilient member as a sprung cradle 114 is that cleaning of the arrangement is made easier and small debris, such as pieces of grit or stone can be worked free from the slot 102 during maintenance.

Alternatively, the elastically resilient member may be provided as an elastomeric support member that can compress in the same manner as the springs 116 shown in FIG. 8. The elastomeric support member may be used in combination with a liner 101 or with a bearing arrangement 110. A bump stop 118 may also be included underneath the elastically resilient member to limit the downwards movement of the inner sleeve 22. Like the bearing arrangement 110 and the cradle 114, when the conduit 10 comprises an elastically resilient member in the form of an elastomeric support member, the elastomeric support member can be provided as a single member extending along the length of the conduit 10 along the longitudinal axis L or as a series of individual elastomeric support members spaced along the length of the conduit 10.

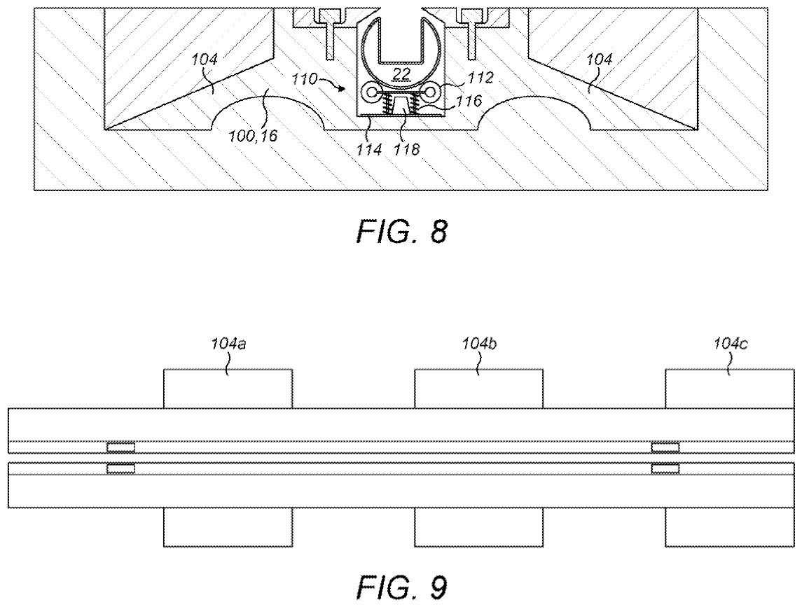

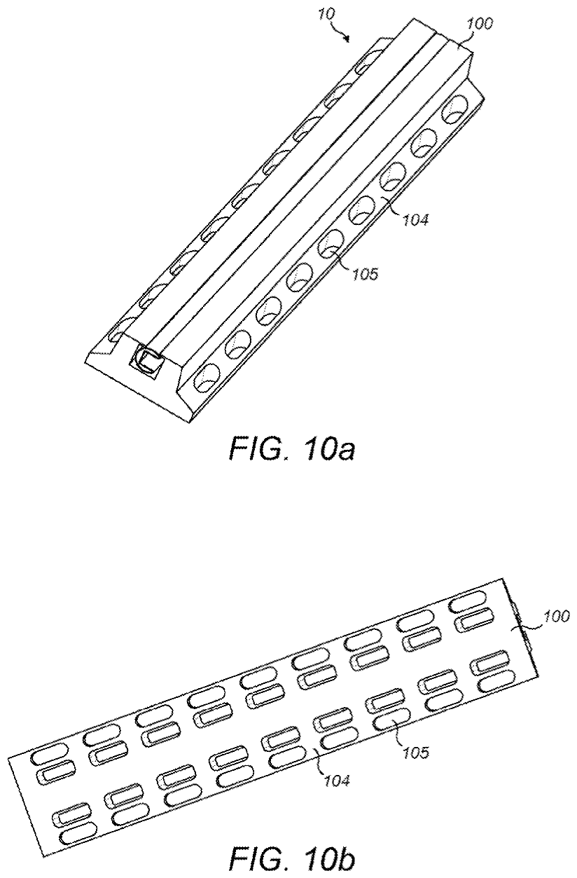

In both the embodiment shown in FIGS. 7 and 8, weight and material can be saved by selectively removing portions of the skirt 104 of the base structure 100. For example, the skirt 104 may be entirely removed from the conduit 10 at certain sections along the length of the arrangement to effectively provide a longitudinal series of skirt sections 104a, 104b, 104c, with gaps in between, as shown in the plan view of FIG. 9. Alternatively, the material can be removed by creating a series of cavities 105 in the skirt 104, as shown in FIGS. 10a and 10b. The cavities 105 extend throughout the height of the skirt 104 in FIGS. 10a and 10b to form open bores, but could also only extend part-way through the skirt 104 to form blind bores.

The first open channel 18 may additionally provide a drainage channel to help prevent the charging cable 12 from being submerged and damaged by rainwater that enters the conduit 10.

Many modifications may be made to the specific examples described above without departing from the scope of the invention as defined in the accompanying claims.

This application is a 371 U.S. National Phase of International Application No. PCT/GB2022/051593, filed on Jun. 22, 2022, which claims priority to GB Patent Application No. 2108957.8, filed on Jun. 22, 2021. The entire disclosures of the above applications are incorporated herein by reference.

1-38. (canceled)

39. An arrangement for providing a charging connection for an electric vehicle, the arrangement comprising:
an elongate groove formed in a surface of a pavement or sidewalk; and
a conduit received within the elongate groove, the conduit comprising:
an outer sleeve comprising a first open channel defining a first longitudinal aperture; and
an inner sleeve arranged within the first open channel, the inner sleeve comprising a second open channel for receiving a vehicle charging cable, the second open channel defining a second longitudinal aperture,
the conduit having an open state and a closed state,
wherein in the open state the first and second longitudinal apertures are mutually aligned so that the conduit defines an opening at the surface of the pavement or sidewalk, through which at least a portion of the vehicle charging cable may be inserted into the second open channel of the conduit, and in the closed state an exposed surface of the conduit at the surface of the pavement or sidewalk covers the vehicle charging cable, and
wherein the inner sleeve is rotatable within the outer sleeve to move the conduit between the open and closed states.

40. The arrangement of claim 39, wherein the exposed surface of the conduit is a surface of the inner sleeve.

41. The arrangement of claim 39, wherein the exposed surface of the conduit is substantially flush with the surface of the pavement or sidewalk when the conduit is in the closed state.

42. The arrangement of claim 39, wherein the inner sleeve rests against a bearing arrangement in the outer sleeve.

43. The arrangement of claim 42, wherein the bearing arrangement comprises roller bearings against which the inner sleeve rotates to move the conduit between the open and closed states.

44. The arrangement of claim 39, wherein the inner sleeve is supported by an elastically resilient member.

45. The arrangement of claim 44, wherein the elastically resilient member comprises a spring.

46. The arrangement of claim 44, wherein the elastically resilient member comprises an elastomeric material.

47. The arrangement of claim 39, wherein the conduit comprises a base structure received within the groove.

48. The arrangement of claim 47, wherein the outer sleeve is formed integrally with the base structure.

49. The arrangement of claim 47, wherein the base structure is formed from rubber or another resiliently deformable material.

50. The arrangement of claim 47, wherein the base structure comprises an outwardly-extending skirt, and wherein the skirt is covered by an infill.

51. The arrangement of claim 39, wherein the groove and the conduit extend transversely across the width of the pavement or sidewalk.

52. The arrangement of claim 39, wherein the groove and the conduit extend between a domestic residence on one side of the pavement or sidewalk and a road providing on-street parking on the other side of the pavement or sidewalk.

53. The arrangement of claim 39, wherein the groove in the pavement or sidewalk is a shallow groove.

54. The arrangement of claim 39, wherein the groove in the pavement or sidewalk has a depth of approximately 80 mm or less.

55. The arrangement of claim 39, wherein the outer and/or the inner sleeve of the conduit are extruded parts.

56. The arrangement of claim 39, wherein the outer and/or the inner sleeve of the conduit are made of plastic, metal, or a composite material such as fibre-reinforced polymer.

57. The arrangement of claim 39, wherein the outer and/or the inner sleeve of the conduit are plastic extrusions or aluminium extrusions.

58. A method of installing the arrangement of claim 39, the method comprising:
forming an elongate groove within a pavement or sidewalk; and
providing a conduit in said groove, the conduit comprising:
an outer sleeve comprising a first open channel defining a first longitudinal aperture; and
an inner sleeve arranged within the first open channel, the inner sleeve comprising a second open channel for receiving a vehicle charging cable, the second open channel defining a second longitudinal aperture;
wherein the inner sleeve is rotatable within the outer sleeve to move the conduit between open and closed states, and wherein the first and second longitudinal apertures are mutually aligned when the conduit is in the open state.

59. The method of claim 58, wherein the conduit further comprises a base structure and wherein the method comprises:
installing the base structure within the groove;
subsequently installing the inner sleeve within the base structure.

60. The method of claim 58, comprising forming the groove to a depth of 80 mm or less.

61. A method for charging an electric vehicle using the arrangement of claim 39, the method comprising:
providing a charging cable;
rotating the inner sleeve of the conduit within the outer sleeve of the conduit to move the conduit to the open state and reveal the opening defined at the surface of the pavement or sidewalk by mutual alignment of the first and second longitudinal apertures;
inserting a portion of the charging cable into the second open channel of the conduit through the opening;
closing the conduit by rotating the inner sleeve within the outer sleeve such that an exposed surface of the conduit at the surface of the pavement or sidewalk covers said portion of the charging cable;
connecting a first end of the vehicle charging cable to a power supply; and
connecting a second end of the charging cable to the electric vehicle.

62. The method of claim 61, wherein the power supply is a domestic power supply.

63. The method of claim 61, wherein the electric vehicle is parked on a road.
